(19) United States
(12) Patent Application Publication
(10) Pub. No.: US 2008/0104439 A1
(43) Pub. Date: May 1, 2008

(54) REAL TIME CLOCK HAVING A REGISTER

(75) Inventors: Chun-Te Yu, Shulin City (TW); Kun-Nan Wu, Sunchung City (TW)

Correspondence Address: MOXA TECHNOLOGIES CO., LTD, P.O. BOX 108-00403, TAIPEI, omitted

(73) Assignee: MOXA TECHNOLOGIES CO., LTD., Shing Tien City (TW)

(21) Appl. No.: 11/554,593

(22) Filed: Oct. 31, 2006

(51) Int. Cl. G06F 1/00

(52) U.S. Cl. 713/500

(57) ABSTRACT

In a real time clock having a register, a preinstalled central processing unit issues a control instruction to hold a time stamp of an external register in the real time clock and then reads the time stamp of the external register, if a server or a control end needs to read the time stamp of the real time clock. The real time clock having a register is comprised of a timing generator for generating a time stamp that is stored in the external register and a controller for controlling the timing generator and the external register. The preinstalled central processing unit can read the time stamp stored in the external register, so as to accurately read the time of issuing a read command given by the central processing unit, regardless of whether or not the preinstalled central processing unit is situated in a busy state of executing other programs.

### BACKGROUND OF THE INVENTION

1. Field of the Invention

The present invention relates to a real time clock having a register, and more particularly to a real time clock using a control command of a preinstalled central processing unit to hold a time stamp in an external register of the real time clock, so as to achieve the function of accurately reading the exact time of issuing a read command by the central processing unit regardless of whether or not the preinstalled central processing unit is at a busy state.

2. Description of Related Art

As the present electronic technology grows rapidly, various different electronic products have become indispensable tools for our life or work. However, a real time clock is an electronic component that works silently and also plays an important role in various different electronic products such as computers and automated control equipments.

If a real time clock in a general electronic system loses its accuracy, and the electronic system such as a server has to provide data and time of transmitting data to a user over the network or a computer system has to provide accurate date and time of executing an application program, then the overall system performance and accuracy will be affected adversely, or the server will be crashed due to errors.

Further, a general computer system always comes with a real time clock for counting time in the computer system, and the real time clock is usually used for producing a time record of data access and program computation. To achieve the aforementioned functions, the real time clock is used directly as a device for reading a computer system time, and the current available method of reading a real time clock reads the time counted by a real time clock chip through a serial method. If the real time clock chips still counts the time while the central processing unit is reading a serial data, then the time so read will not be the desired moment. If the reading time of the central processing unit is too long, even the number of seconds or minutes will be read, so that if the number of second is precisely equal to 0 minute 59 seconds which is rounded up to 1 minute 0 second, but the real time so read is equal to 0 minute 0 second, the read time will be one minute slower than the actual time. Similarly, if the carry is precisely a whole hour, a whole day or even a whole month, the error of real time so read will be very large, and thus greatly increasing the instability of the electronic system.

Obviously, the prior art requires further improvements, and such improvements become good research and development subjects for manufacturers in the related industry.

### SUMMARY OF THE INVENTION

In view of the foregoing shortcomings and deficiency, the inventor of the present invention based on years of experience in the related industry to conduct extensive researches and experiments, and finally invented a real time clock having a register in accordance with the present invention.

Therefore, it is a primary objective of the present invention to adopt an external register in a real time clock chip module to accurately read the correct time of a read command given by the central processing unit, regardless of whether or not the central processing unit is situated at a busy state of executing other programs.

A secondary objective of the present invention is to use an interrupt signal pin in an external control terminal to read and determine the time of an occurrence of an external event, such that if there is a special event occurred in the program or system, the read signal start pin will be triggered, and thus users can accurately check the exact triggering time of the event.

### BRIEF DESCRIPTION OF THE DRAWINGS

FIG. 1 is a block diagram of a system of the present invention.

FIG. 2 is a schematic view of the architecture of a first preferred embodiment of the present invention.

FIG. 3 is a schematic view of the architecture of a second preferred embodiment of the present invention.

FIG. 4 is a schematic view of the architecture of a third preferred embodiment of the present invention.

FIG. 5 is a schematic view of the architecture of a fourth preferred embodiment of the present invention.

### DETAILED DESCRIPTION OF THE PREFERRED EMBODIMENTS

To achieve the foregoing objectives and effects, the objectives, structure, innovative features, and performance of the present invention will be apparent in the following detailed description of the preferred embodiments with reference to the accompanying drawings.

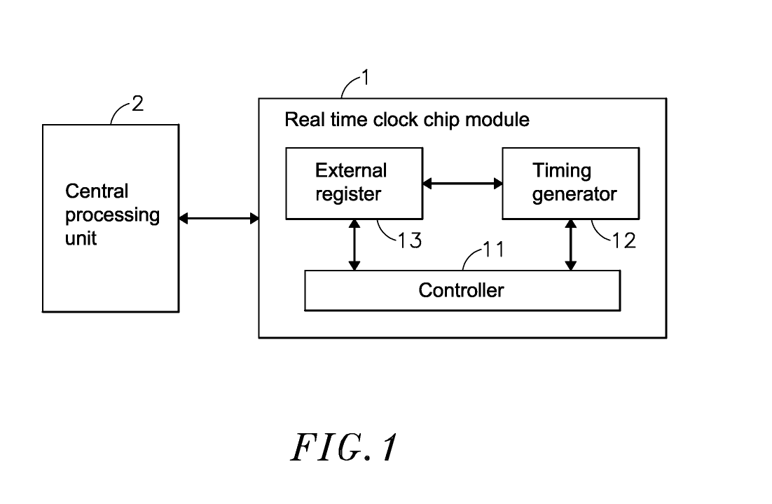

Referring to FIG. 1 for a block diagram of a system in accordance of a preferred embodiment of the present invention, a real time clock having a register of the invention is comprised of a real time clock chip module 1, and the real time clock chip module 1 is comprised of a controller 11, a timing generator 12 and an external register 13, and the characteristics of the main structure of the invention are described as follows.

The controller 11 is a control unit of a real time clock chip module 1, and an external control terminal of the controller 11 can be used for controlling the operations of the timing generator 12 and the external register 13 that are electrically coupled to the controller 11.

The timing generator 12 is provided for generating a time stamp including year, month, day, hour, minute, and second, etc.

The external register 13 is electrically coupled to the timing generator 12 and capable of saving the time stamp produced by the timing generator 12 into the external register 13.

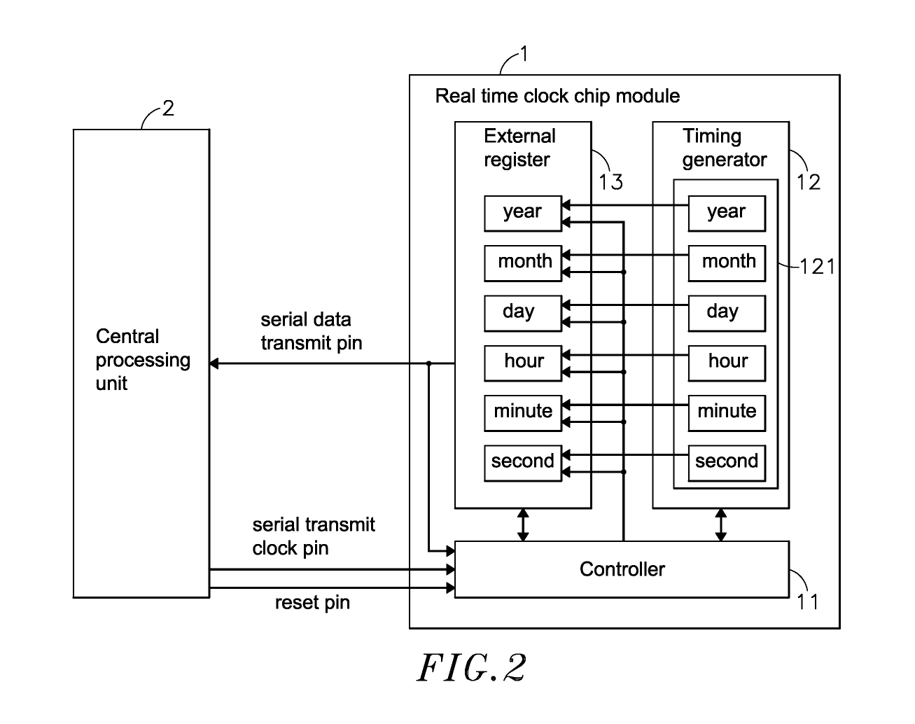

Referring to FIG. 2 for a schematic view of the architecture of a first preferred embodiment of the present invention, the central processing unit 2 issues a control command to the controller 11 when the external central processing unit 2 needs to read the time of the timing generator 12, and then the controller 11 issues a read command to the timing generator 12, and finally writes the time stamp stored in the internal register 121 of the timing generator 12 into the external register 13, and stops updating the time stamp in the external register 13. After the time for the central processing unit 2 issuing a read command is written into the external register 13 and the update of the time stamp in the external register 13 is stopped, a correct reading time can be obtained accurately regardless of whether or not the central processing unit 2 is situated at a busy state of executing other programs.

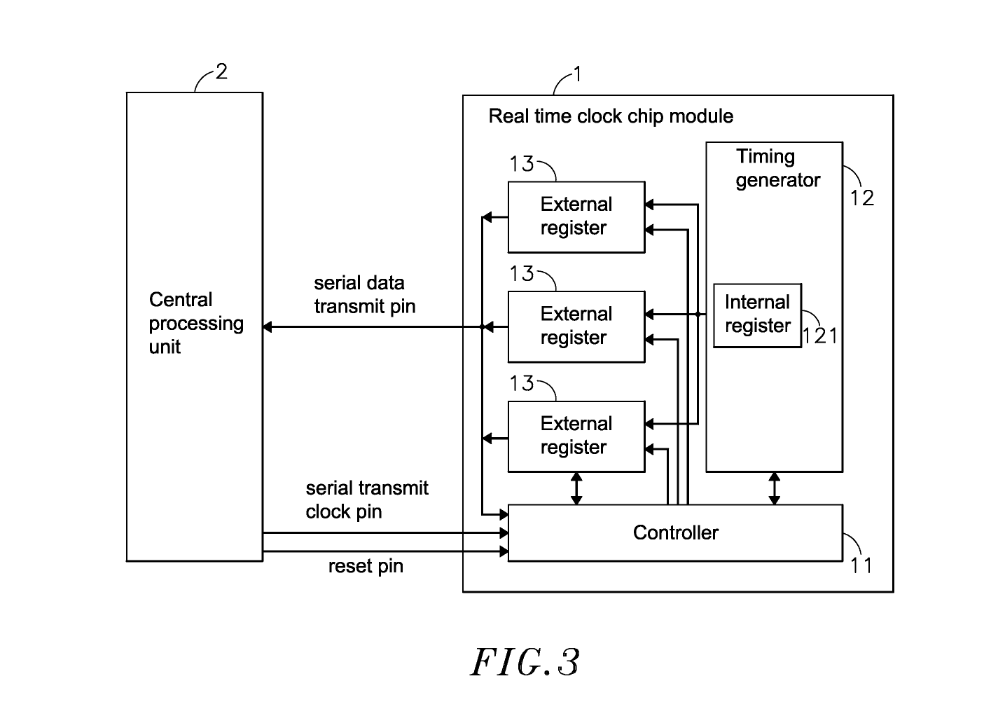

Referring to FIG. 3 for a schematic view of the architecture of a second preferred embodiment of the present invention, its main difference from the preferred embodiment illustrated in FIG. 2 resides on that the real time clock chip module 1 includes more than one external registers 13, and the plurality of external registers 13 are electrically and respectively coupled to the controller 11 and the timing generator 12, so that the central processing unit 2 can read different time stamps respectively stored in more than one external registers 13.

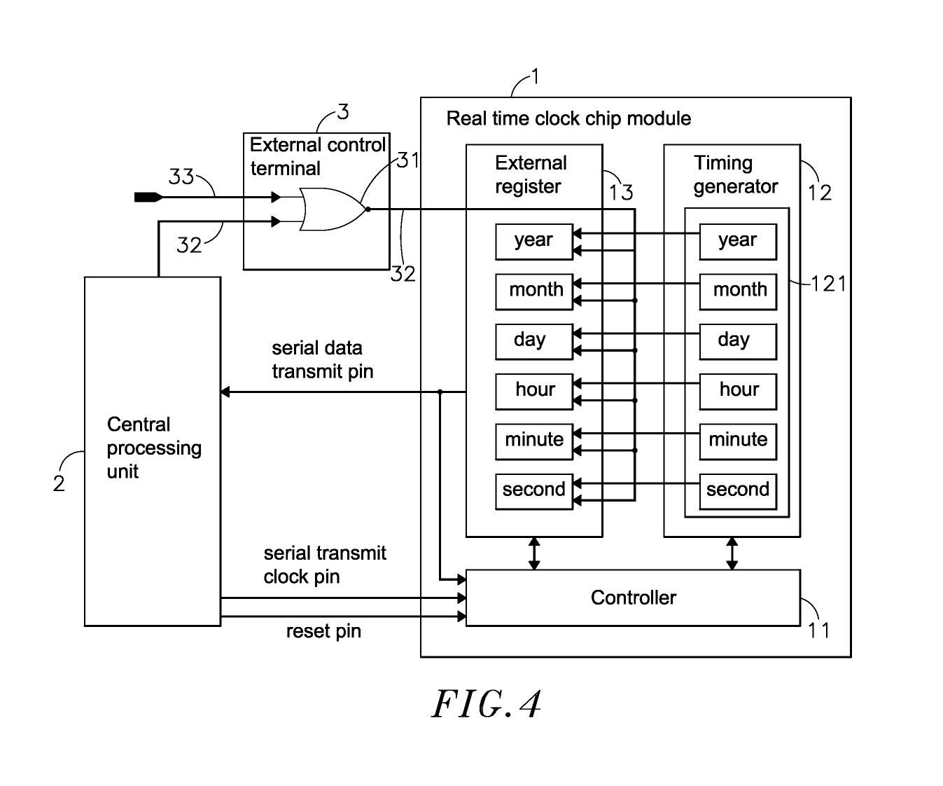

Referring to FIG. 4 for a schematic view of the architecture of a third preferred embodiment of the present invention, its main difference from the preferred embodiment illustrated in FIG. 2 resides on that the real time clock chip module 1 and the central processing unit 2 further includes an external control terminal 3, such that when the external central processing unit 2 needs to read the time of the timing generator 12, the central processing unit 2 triggers a read signal start pin 32 of the external control terminal 3 to write the time stamp stored in the internal register 121 into the external register 13. After the reading time issued by the central processing unit 2 is written into the external register 13 and held, a correct time can be read accurately regardless of whether or not the central processing unit 2 is situated at a busy state of executing other programs. The external control terminal 3 also has an interrupt signal pin 33 for adding and determining the reading of time when the external event occurs. For instance, if an event occurs, then the real time clock chip module 1 will determine the operation of the read signal start pin 32 to buffer the time, and then the central processing unit 2 also can know the correct time when the event occurs, and the central processing unit 2 reads the time for the interrupt, and the time recorded by then is the correct time of the occurrence of the event instead of the time read after the central processing unit 2 determines an interrupt condition. Therefore, the correct time for the occurrence of the event can be obtained.

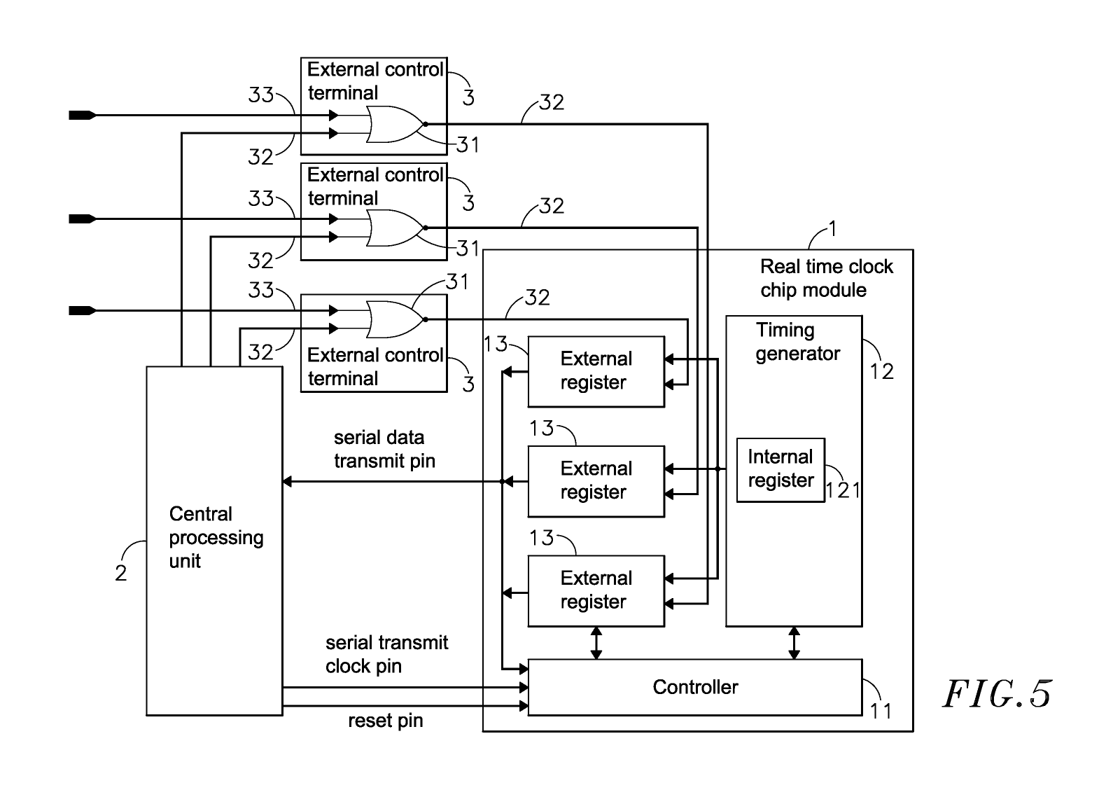

Referring to FIG. 5 for a schematic view of the architecture of a fourth preferred embodiment of the present invention, its main difference from the preferred embodiment illustrated in FIG. 4 resides on that the real time clock chip module 1 and the central processing unit 2 further include one or more external control terminals 3 respectively and electrically coupled to the corresponding external registers 13. Similarly, the central processing unit 2 can read the time stamp stored in one or more external registers 13.

The aforementioned central processing unit 2 could be the S3C2500B chip produced Samsung, and the logic gate 31 could be the 74LVC1G32 logic gate produced by Texas Instruments. Further, the time stamp could be in a unit of time such as year, month, day, hour, minute, second or millisecond.

While the invention has been described by means of specific embodiments, numerous modifications and variations could be made thereto by those skilled in the art without departing from the scope and spirit of the invention set forth in the claims.

In summation of the description above, the technical measures and implementation method of the real time clock having a register of the invention have the following advantages over the prior art:

(1) The external register 13 installed in the real time clock chip module 1 of the invention can accurately read the correct time of a read command issued by the central processing unit 2, regardless of whether or not the central processing unit 2 is situated at a busy state of executing other programs. Unlike the traditional real time clock chip that may read an unintended moment while the chip is still counting the time, the present invention will not result a time jump even if the reading time of the central processing unit 2 is too long, and users need not use software to avoid a carry error of the time counted by the real time clock.

(2) The present invention uses the interrupt signal pin 33 installed in the external control terminal 3 to add and determine the reading of time when an external event occurs. If there is a special event occurred in the program or system, the read signal start pin 32 will be triggered, such that the external register 13 records the triggering time of the event, and thus users can accurately check the correct triggering time of the event.

(3) The present invention uses a plurality of external registers 13 to add the reading of the triggering time to the central processing unit 2. If there is one or more special events occurred in the program or system, the central processing unit 2 allows one or more external registers 13 to record the triggering time of the event, and thus users can accurately check the correct time for triggering different events.

While the invention has been described by means of specific embodiments, numerous modifications and variations could be made thereto by those skilled in the art without departing from the scope and spirit of the invention set forth in the claims.

What is claimed is:

1. A real time clock having a register, applicable to an electronic device, such that when a preinstalled central processing unit needs to read a time stamp, said time stamp in said external register of said real time clock is held, and then said preinstalled central processing unit reads said time stamp of said external register, and said real time clock having a register comprising a controller, a timing generator and one or more external registers; characterized in that:
said timing generator is provided for producing a time stamp;
said one or more external registers are electrically coupled to said timing generator, for storing said time stamp produced by said timing generator therein; and
said controller is electrically coupled to said timing generator and one or more external registers and serves as a control element for controlling said timing generator and one or more external registers.

2. The real time clock having a register of claim 1, wherein said time stamp generated by said timing generator is in a unit of time selected from the collection of year, month, day, hour, minute, second or millisecond.

3. The real time clock having a register of claim 1, wherein said controller can receive an instruction or a command given by said preinstalled central processing unit for reading said time stamp.

4. A real time clock having a register, applicable to an electronic device, such that when a preinstalled central processing unit needs to read a time stamp, said time stamp in said external register of said real time clock is held by one or more external control terminals, and then said preinstalled central processing unit reads said time stamp of said external register, and said real time clock having an external register comprising a controller, a timing generator and one or more external registers; characterized in that:
said timing generator is provided for producing said time stamp;
said external register is electrically coupled to said timing generator for saving said time stamp produced by said timing generator therein; and
said controller is electrically coupled to said timing generator and said external register and serves as a control unit for controlling said timing generator and said external register.

5. The real time clock having a register of claim 4, wherein said time stamp generated by said timing generator is in a unit of time selected from the collection of year, month, day, hour, minute, second or millisecond.

6. The real time clock having a register of claim 4, wherein said one or more external control terminal is comprised of a logic gate, a read signal start pin and an interrupt signal pin.
